(19) United States
(12) Patent Application Publication
(10) Pub. No.: US 2026/0100922 A1
(43) Pub. Date: Apr. 9, 2026

(54) INSTANT MESSAGING CHAT INFORMATION PROCESSING METHOD, STORAGE MEDIUM AND ELECTRONIC DEVICE

(71) Applicant: BEIJING ZITIAO NETWORK TECHNOLOGY CO., LTD., Beijing (CN)

(72) Inventors: Wei CAI, Beijing (CN); Chen WANG, Beijing (CN); Penglin LI, Beijing (CN); Chen ZHAO, Beijing (CN); Shujun LI, Beijing (CN)

(21) Appl. No.: 19/103,942

(22) PCT Filed: Nov. 22, 2023
(86) PCT No.: PCT/CN2023/133108

§ 371 Date: Feb. 14, 2025

(30) Foreign Application Priority Data
Nov. 23, 2022 (CN) 202211474710.9

(51) Int. Cl. H04L 51/02

(52) U.S. Cl. CPC H04L 51/02

(57) ABSTRACT

An instant messaging chat information processing method and an electronic device are provided. The instant messaging chat information processing method includes: receiving a chat mode switching operation for a target chat; and switching the target chat from a first chat mode to a second chat mode in response to the chat mode switching operation, where chat message management manners in different chat modes are different, and the first chat mode and the second chat mode are different chat modes.

The present application claims priority to Chinese Patent Application No. 202211474710.9, filed on Nov. 23, 2022, which is incorporated herein by reference in its entirety as a part of the present application.

### TECHNICAL FIELD

The present disclosure relates to an instant messaging chat information processing method and apparatus, and an electronic device.

### BACKGROUND

With the continuous development of computer software technologies, instant messaging tools are increasingly used in people's work and life. An instant messaging tool has a group chat function in order for people to have a chat with group members in a group through the instant messaging tool, especially to discuss hot topics with the group members in the group. However, in the case of a large number of group members, a plurality of topics may be discussed among different members, making the content for the same topic excessively scattered, which makes it more difficult for the group members to read information.

### SUMMARY

The present disclosure provides an instant messaging chat information processing method and apparatus, and an electronic device.

According to a first aspect, an instant messaging chat information processing method is provided. The method includes:

receiving a chat mode switching operation for a target chat; and

switching the target chat from a first chat mode to a second chat mode in response to the chat mode switching operation,

where chat message management manners in different chat modes are different, and the first chat mode and the second chat mode are different chat modes.

According to a second aspect, an instant messaging chat information processing apparatus is provided. The apparatus includes a receiving module and a switching module.

The receiving module is configured to receive a chat mode switching operation for a target chat.

The switching module is configured to switch the target chat from a first chat mode to a second chat mode in response to the chat mode switching operation, where chat message management manners in different chat modes are different, and the first chat mode and the second chat mode are different chat modes.

According to a third aspect, a computer-readable storage medium is provided. The storage medium stores a computer program, where when the computer program is executed by a processor, the processor implements the method according to any one of the first aspect.

According to a fourth aspect, an electronic device is provided. The electronic device includes a memory, a processor, and a computer program that is stored on the memory and executable on the processor. When the processor executes the program, the processor implements the method according to any one of the first aspect.

It should be understood that the above general description and the following detailed description are merely exemplary and illustrative, and are not intended to limit the present disclosure.

### BRIEF DESCRIPTION OF DRAWINGS

In order to describe the technical solutions in the embodiments of the present disclosure more clearly, the accompanying drawings for describing the embodiments are briefly described below. Apparently, the accompanying drawings in the following description are merely some embodiments of the present disclosure, and those skilled in the art may derive other accompanying drawings from these accompanying drawings without creative efforts.

FIG. 1a is a schematic diagram of a chat interface for an instant messaging client according to an exemplary embodiment of the present disclosure;

FIG. 1b is a schematic diagram of another interface for an instant messaging client according to an exemplary embodiment of the present disclosure;

FIG. 1c is a schematic diagram of yet another interface for an instant messaging client according to an exemplary embodiment of the present disclosure;

FIG. 1d is a schematic diagram of still another interface for an instant messaging client according to an exemplary embodiment of the present disclosure;

FIG. 1e is a schematic diagram of another interface for an instant messaging client according to an exemplary embodiment of the present disclosure;

FIG. 2 is a flowchart of a method for an instant messaging client according to an exemplary embodiment of the present disclosure;

FIG. 3 is a block diagram of an apparatus for an instant messaging client according to an exemplary embodiment of the present disclosure;

FIG. 4 is a schematic block diagram of an electronic device according to some embodiments of the present disclosure;

FIG. 5 is a schematic block diagram of another electronic device according to some embodiments of the present disclosure; and

FIG. 6 is a schematic diagram of a storage medium according to some embodiments of the present disclosure.

### DETAILED DESCRIPTION

In order to make those skilled in the art better understand the technical solutions in the present disclosure, the technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by those of ordinary skill in the art based on the embodiments of the present disclosure without creative efforts shall fall within the scope of protection of the present disclosure.

When the following description relates to the accompanying drawings, the same numerals in different accompanying drawings denote the same or similar elements, unless otherwise indicated. The implementations described in the following exemplary embodiments do not represent all the implementations consistent with the present disclosure. Rather, they are merely examples of apparatuses and methods that are consistent with some aspects of the present disclosure and that are described in detail in the appended claims.

The terms used in the present disclosure are used only to describe specific embodiments rather than limit the present disclosure. The singular forms “a”, “the”, and “the” used in the present disclosure are also intended to include plural forms unless the context clearly indicates otherwise. It should also be understood that the term “and/or” used herein refers to any or all of possible combinations including one or more associated listed items.

It should be understood that although the terms “first”, “second”, “third”, and the like may be used in the present disclosure to describe various information, these information should not be limited to these terms. These terms are only used to distinguish the same type of information from each other. For example, without departing from the scope of the present disclosure, first information may also be referred to as second information, and similarly, second information may also be referred to as first information. Depending on the context, for example, the term “if” used herein may be explained as “when” or “while” or “in response to . . . , it is determined that”.

With the continuous development of computer software technologies, instant messaging tools are increasingly used in people's work and life. An instant messaging tool has a group chat function in order for people to have a chat with group members in a group through the instant messaging tool, especially to discuss hot topics with the group members in the group. However, in the case of a large number of group members, a plurality of topics may be discussed among different members, making the content for the same topic excessively scattered and difficult to aggregate, which makes it more difficult for the group members to read information.

In the related art, a user can create a topic-mode group through an instant messaging tool and discuss different topics with group members in the topic-mode group. Each topic corresponds to a topic area, and related information of the topic is displayed in the topic area corresponding to the topic. However, after the topic-mode group is created, the group members can only interact with each other in the topic mode, which poses some limitations.

In an instant messaging chat information processing method provided in the present disclosure, a target chat in an instant messaging client is switched from one chat mode to another chat mode by chat mode switching performed by the user for the target chat, so that conversation messages are managed in different chat message management manners in different chat modes, which extends the functions of instant messaging chats and improves user experience.

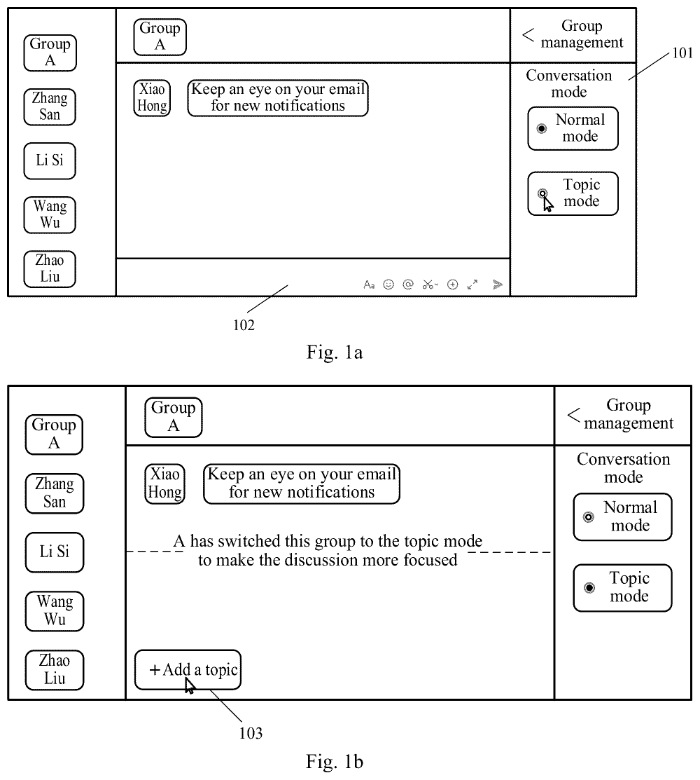

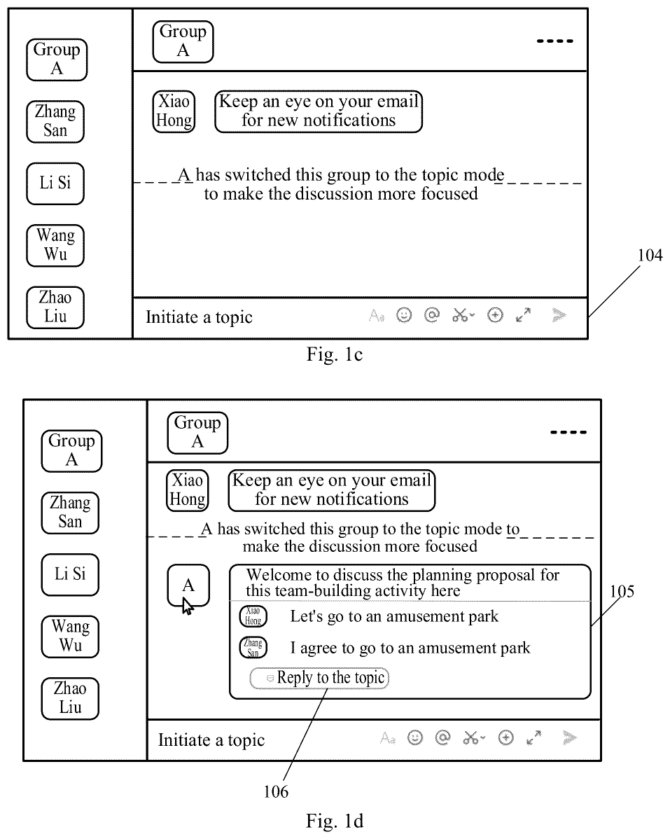

FIG. 1a is a schematic diagram of a chat interface for an instant messaging client according to an exemplary embodiment. For example, a user A who logs into the instant messaging client is a group member of a group A, the group A is the name of the group, and the user A may be the administrator of the group A and has several group management permissions, including the permission to manage a chat mode of a group chat.

As shown in FIG. 1a, on the chat interface of the group A, for example, by triggering a group management button, the user A may bring up a sidebar 101 displaying group management items, including chat mode management items,. The chat mode management items include a normal mode and a topic mode. The user A may switch the chat mode by clicking an option button in front of the normal mode or an option button in front of the topic mode. Specifically, for example, the current chat mode is the normal mode, then the user A may click the option button in front of the topic mode and confirm to continue the switching. The instant messaging client sends a chat mode switching request for the group A to a server in response to a chat mode switching operation performed by the user A for the group A. A chat attribute set R of the group A is pre-stored in the server, and includes attribute values of attributes corresponding to the group A, where the attribute values include an attribute value of a chat mode attribute. After receiving the chat mode switching request, the server may update the attribute value of the chat mode attribute included in chat attribute set R, so as to update an attribute value a corresponding to the normal mode to an attribute value b corresponding to the topic mode.

Then, the server may push an update message to clients of members (including the user A) of the group A, and the update message includes the chat attribute set R. After receiving the update message, the clients of the members of the group A may check the attribute values of the attributes in the chat attribute set R. When it is determined that the attribute value of the chat mode attribute changes from a to b, the chat corresponding to the group A is switched from the normal mode to the topic mode. Optionally, the server may further push a system notification message to the members of the group A, and the system notification message informs the members that the user A has updated the chat mode of the group A.

FIG. 1b is a schematic diagram of a chat interface after the chat corresponding to the group A is switched from the normal mode to the topic mode. As shown in FIG. 1b, the chat interface of the group A displays a notification message with the content “A has switched this group to the topic mode to make the discussion more focused”. In addition, the chat interface hides a message input box 102 shown in FIG. 1a, and displays a topic creation button 103 to prevent the user from sending a reply to an existing topic as a new topic due to maloperation. After the user triggers the topic creation button, for example, by clicking or other manners, a topic input box is displayed.

FIG. 1c is a schematic diagram of a chat interface after the user triggers the topic creation button. For example, after the user A triggers the topic creation button 103 by clicking, the topic input box 104 is displayed on the chat interface. The user A may input topic content into the topic input box 104, and send the topic content to the group A to create and initiate a new topic.

FIG. 1d is a schematic diagram of a chat interface after the user initiates a topic. After the user A sends the topic content to the group A, the chat interface displays a topic card 105 corresponding to the topic content in a management manner of the topic mode. The topic card 105 may be displayed behind an avatar of the user A, and the topic card 105 includes a topic area for displaying the topic content and a comment area for displaying comment content. A reply input box 106 for inputting comment content is displayed below the comment area, and members in the group A who participate in the topic may input and send comment content for the topic through the reply input box 106. When the topic corresponds to excessive topic content or comment content, some topic content or comment content may be collapsed in the topic card 105. The user may further bring up a sidebar corresponding to the topic, expand a topic detail interface corresponding to the topic in the sidebar, and display detailed content corresponding to the topic in the topic detail interface through an operation of viewing the topic, thereby expanding a display area corresponding to the topic.

FIG. 1e is a schematic diagram of a chat interface after the user brings up the sidebar for the topic. Specifically, the user may bring up a sidebar 107 corresponding to the topic by triggering (such as clicking) any area of the topic card 105 or the avatar of the user A in front of the topic card 105. The sidebar 107 displays the full topic content and comment content corresponding to the topic for the user to view. In addition, a reply input box 108 for inputting comment content is displayed at the bottom of the sidebar 107, and members in group A who participate in the topic may also input and send comment content for the topic through the reply input box 108.

It should be noted that after the chat corresponding to the group A is switched from the normal mode to the topic mode, a historical message received before the switching is still displayed in the original manner, that is, still managed in the normal mode. A new message received after the switching is managed in the topic mode. When the chat mode is switched from the topic mode back to the normal mode, a message received after another switching is managed in the normal mode again.

In the solutions provided in this embodiment, the target chat in the instant messaging client is switched from one chat mode to another chat mode by the chat mode switching performed by the user for the target chat, so that conversation messages are managed in different chat message management manners in different chat modes, which extends the functions of instant messaging chats and improves user experience. For example, in some scenarios, at the beginning of the creation of a normal-mode group, since there are fewer group members and less discussion content, there is no obstacle to reading chat messages one by one. However, as the number of group members grows, there are more and more messages with scattered content in the group, and the messages become increasingly confusing. In this case, converting the group into a topic group can solve the problem well.

Further, after the target chat is switched from the first chat mode to the second chat mode, a display manner of a historical chat message remains unchanged, and a new chat message is displayed in a chat message display manner corresponding to the second chat mode, thereby improving the display effect of the chat message and further improving user experience.

Still further, the chat interface hides the message input box displayed for the target chat in the normal mode, and displays the topic creation button. The chat interface displays the topic input box after the operation of triggering the topic creation button by the user, thereby preventing the user from sending a reply to an existing topic as a new topic due to maloperation, further improving user experience.

Still further, the target chat displays a topic card corresponding to each topic, and the topic card corresponding to any topic displays topic content corresponding to the topic, thereby making the content for the same topic more aggregated, and also making the operation by the user more convenient, further improving user experience.

Still further, under the trigger of the operation of viewing the topic by the user, the topic detail interface corresponding to the topic is expanded in the sidebar, and the topic detail interface displays detailed content corresponding to the topic, thereby expanding a display area corresponding to the topic, which makes it easier for the user to view topic messages, further improving user experience.

The present disclosure is described in detail below with reference to specific embodiments.

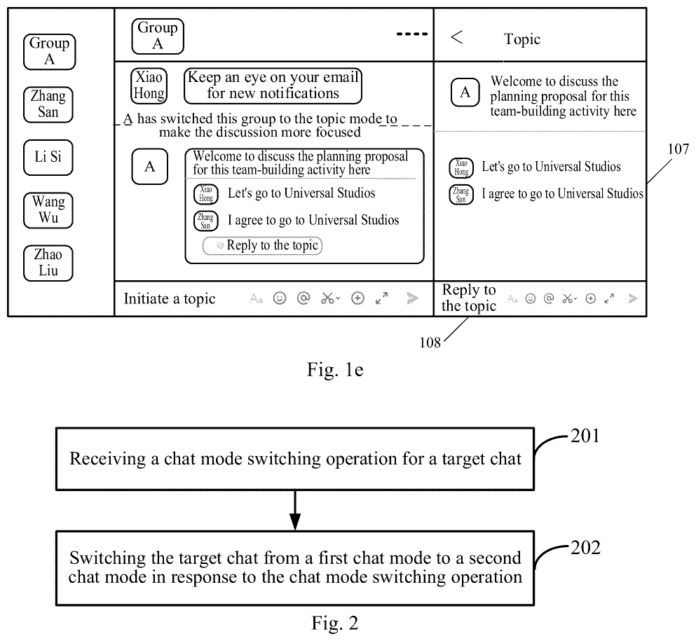

FIG. 2 is a flowchart of an instant messaging chat information processing method according to an exemplary embodiment. The method may be applied to a terminal device. In this embodiment, for ease of understanding, an example is provided in combination with a terminal device that can be installed with a third-party instant messaging client. Those skilled in the art may understand that the terminal device may include, but is not limited to, a mobile terminal device such as a smartphone, a smart wearable device, a tablet computer, and the like. The method may include the following steps.

As shown in FIG. 2, in the step 201, receiving a chat mode switching operation for a target chat.

In this embodiment, the target chat may be a group chat of a target group created in the instant messaging client. The instant messaging client may be a third-party application installed on the terminal device. A user may perform instant messaging with group members of the target group through the group chat in the instant messaging client. The target chat may include at least two chat modes. For example, the chat modes may include, but are not limited to, a normal mode and a topic mode.

Chat message management manners in different chat modes are different. For example, the chat message management manners in different chat modes may have at least one of the following being different: a chat message display manner, a chat message sending manner, and a chat message notification manner. Different chat message management manners are exemplified below by using an example in which the chat modes include a normal mode and a topic mode.

For the chat message display manner, in the normal mode, chat messages may be displayed on a chat interface in a dialog manner in the chronological order in which the chat messages are sent. However, in the topic mode, topics may be displayed on the chat interface in the form of topic cards in the chronological order in which the topics are created. Each topic card displays topic content and topic comments associated with the topic.

For the chat message sending manner, in the normal mode, the chat interface may directly display a message input box, and the user may directly input a chat message into the message input box, and send the chat message to the target chat. However, in the topic mode, the chat interface hides the message input box displayed in the normal mode, and displays a topic creation button. After the user triggers the topic creation button, the chat interface displays the topic input box. The user inputs topic content of a new topic through the topic input box and sends the topic content to the target chat. The topic content is displayed in a topic card corresponding to the new topic, and a reply input box is displayed at the bottom of the topic card. The user may input comment content of the new topic through the reply input box, and send the comment content to the target chat.

For the chat message notification manner, in the normal mode, after a new chat message is generated, all group members can receive a new message notification. However, in the topic mode, after a new topic is created, only group members who participate in the new topic can receive the new message notification.

In this embodiment, the chat mode of the target chat may be switched. Specifically, in an implementation, all group members corresponding to the target chat may switch the chat mode of the target chat through a chat mode switching interface provided in the instant messaging client. In another implementation, an operating permission for switching the chat mode may also be preset, so that some group members have the operating permission for switching the chat mode. For example, a group administrator may have the operating permission by default, and the group administrator may also designate some group members to obtain the operating permission. The instant messaging client provides the chat mode switching interface corresponding to the target chat to group members who have the operating permission, but does not provide the chat mode switching interface to group members without the operating permission. Therefore, only the group members who have the operating permission may switch the chat mode of the target chat through the chat mode switching interface.

Then, in the step 202, switching the target chat from a first chat mode to a second chat mode in response to the chat mode switching operation.

In this embodiment, after receiving the chat mode switching operation performed by the user for the target chat, the instant messaging client may send a chat mode switching request to a server. After receiving the chat mode switching request, the server may obtain a pre-stored chat attribute set corresponding to the target chat. The chat attribute set includes attribute values of attributes corresponding to the target chat, the attribute values of attributes include an attribute value of a chat mode attribute, and different attribute values of the chat mode attribute correspond to different chat modes. The server may change the attribute value of the chat mode attribute (namely, changing an attribute value corresponding to the first chat mode to an attribute value corresponding to the second chat mode) based on the chat mode switching request, so as to update the chat attribute set.

Then, the server sends the updated chat attribute set to the group members of the target group. After receiving the chat attribute set sent by the server, instant messaging clients into which the group members of the target group log check the attribute values of the attributes in the chat attribute set. When checking that the attribute value of the chat mode attribute changes, and the changed attribute value corresponds to the second chat mode, the instant messaging clients update the attribute values of the respective chat mode attributes to the attribute value of the second chat mode, so as to switch the target chat from the first chat mode to the second chat mode.

Optionally, after receiving the chat mode switching request, the server may further send a notification message indicating a change in a chat mode of the target chat to the group members of the target group. After receiving the notification message, the instant messaging clients into which the group members of the target group log display the notification message in the target chat interface, so as to inform the group members that the chat mode of the target chat has been switched.

It should be noted that after the target chat is switched from the first chat mode to the second chat mode, the display manner of a chat message that has been generated in the target chat before the switching remains unchanged. For example, a chat message that is generated in the first chat mode before the switching is still displayed in the display manner corresponding to the first chat mode, that is, the display manner remains unchanged. A new chat message that is generated in the target chat after the switching is displayed in a chat message display manner corresponding to the second chat mode.

In the instant messaging chat information processing method provided in the present disclosure, the target chat in the instant messaging client is switched from one chat mode to another chat mode by the chat mode switching performed by the user for the target chat, so that chat messages are managed in different chat message management manners in different chat modes, which extends the functions of instant messaging chats and improves user experience.

Corresponding to the foregoing embodiment of the instant messaging chat information processing method, the present disclosure further provides an embodiment of an instant messaging chat information processing apparatus.

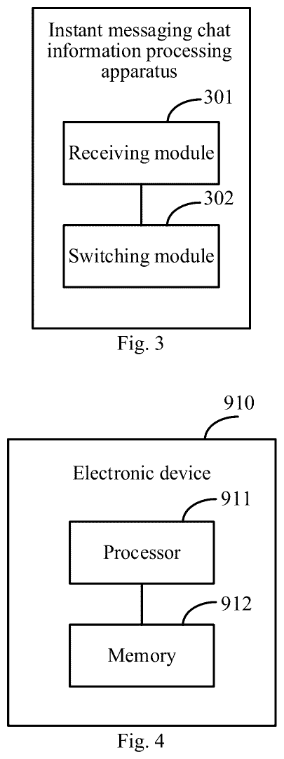

As shown in FIG. 3, FIG. 3 is a block diagram of an instant messaging chat information processing apparatus according to an exemplary embodiment of the present disclosure. The apparatus may include: a receiving module 301 and a switching module 302.

The receiving module 301 is configured to receive a chat mode switching operation for a target chat.

The switching module 302 is configured to switch the target chat from a first chat mode to a second chat mode in response to the chat mode switching operation. Chat message management manners in different chat modes are different, and the first chat mode and the second chat mode are different chat modes.

In some implementations, the chat message management manners in different chat modes being different includes: at least one of a chat message display manner, a chat message sending manner, and a chat message notification manner in different chat modes being different.

In some other implementations, after the switching module 302 switches the target chat from the first chat mode to the second chat mode, a display manner of a chat message that has been generated in the target chat before the switching remains unchanged. A new chat message that is generated in the target chat after the switching is displayed in a chat message display manner corresponding to the second chat mode.

In some other implementations, the switching module 302 may include: a sending submodule, a receiving submodule, and a switching submodule (not shown in the figure).

The sending submodule is configured to send a chat mode switching request to a server in response to the chat mode switching operation.

The receiving submodule is configured to receive a chat attribute set sent by the server, where the chat attribute set includes a chat mode attribute.

The switching submodule is configured to switch the target chat from the first chat mode to the second chat mode when an attribute value of the chat mode attribute included in the chat attribute set is determined to correspond to the second chat mode.

In some other implementations, the apparatus may further include: a notification receiving module and a notification display module (not shown in the figure).

The notification receiving module is configured to receive a notification message sent by the server, where the notification message indicates a change in a chat mode of the target chat, after the chat mode switching request is sent to the server.

The notification display module is configured to display the notification message in a target chat interface.

In some other implementations, the apparatus may further include: an interface display module (not shown in the figure).

The interface display module is configured to display a chat mode switching interface corresponding to the target chat for a user that has a preset permission, before the chat mode switching operation is received.

The receiving a chat mode switching operation for a target chat includes receiving the chat mode switching operation performed by the user that has the preset permission for the target chat on the chat mode switching interface.

In some other implementations, the first chat mode is a normal mode, and the second chat mode is a topic mode.

In some other implementations, the apparatus may further include: a hiding module and an input module (not shown in the figure).

The hiding module is configured to hide a message input box displayed for the target chat in the normal mode, and display a topic creation button, after the target chat is switched from the normal mode to the topic mode.

The input module is configured to display a topic input box in response to an operation of triggering the topic creation button by the user.

In some other implementations, a chat message corresponding to the topic mode may be displayed in the following manner: displaying a topic card corresponding to each topic in the target chat, where a topic card corresponding to any topic displays topic content corresponding to the topic.

In some other implementations, the apparatus may further include: an expansion module (not shown in the figure).

The expansion module is configured to, in response to an operation of viewing a topic by a user, expand a topic detail interface corresponding to the topic in a sidebar, and display detailed content corresponding to the topic in the topic detail interface.

In some other implementations, the operation of viewing the topic includes: an operation of triggering an avatar of a creator of the topic, or an operation of triggering a topic card corresponding to the topic.

The apparatus embodiment is substantially corresponding to the method embodiment, and therefore for a related part, reference may be made to the descriptions of the part in the method embodiment. The apparatus embodiment described above is merely exemplary. The units described as separate parts may or may not be physically separate, and parts displayed as units may or may not be physical units, and may be located at one position, or may be distributed on a plurality of network units. Some or all of the modules may be selected according to actual needs to achieve the objectives of the solutions of the embodiments of the present disclosure, which can be understood and implemented by those of ordinary skill in the art without involving any inventive effort.

FIG. 4 is a schematic block diagram of an electronic device according to some embodiments of the present disclosure. As shown in FIG. 4, the electronic device 910 includes a processor 911 and a memory 912, and may be configured to implement a client or a server. The memory 912 is configured to store computer-executable instructions (for example, one or more computer program modules) in a non-transitory manner. The processor 911 is configured to run the computer-executable instructions. The computer-executable instructions, when run by the processor 911, may perform one or more steps of the instant messaging chat information processing method described above, thereby implementing the instant messaging chat information processing method described above. The memory 912 and the processor 911 may be interconnected via a bus system and/or another form of connection mechanism (not shown).

For example, the processor 911 may be a central processing unit (CPU), a graphics processing unit (GPU), or another form of processing unit having data processing capabilities and/or program execution capabilities. For example, the central processing unit (CPU) may have an X86 or ARM architecture or the like. The processor 911 may be a general-purpose processor or a special-purpose processor, and may control other components in the electronic device 910 to perform a desired function.

For example, the memory 912 may include any combination of one or more computer program products, which may include various forms of computer-readable storage media, such as a volatile memory and/or a non-volatile memory. The volatile memory may include, for example, a random access memory (RAM) and/or a cache memory (cache). The non-volatile memory may include, for example, a read-only memory (ROM), a hard disk, an erasable programmable read-only memory (EPROM), a portable compact disk read-only memory (CD-ROM), a USB memory, and a flash memory. One or more computer program modules may be stored on the computer-readable storage medium. The processor 911 may run the one or more computer program modules to implement various functions of the electronic device 910. Various applications and various data, as well as various data used and/or generated by the applications and the like may further stored in the computer-readable storage medium.

It should be noted that for the specific function and technical effect of the electronic device 910 in the embodiments of the present disclosure, reference may be made to the above description of the instant messaging chat information processing method. Details are not described herein again.

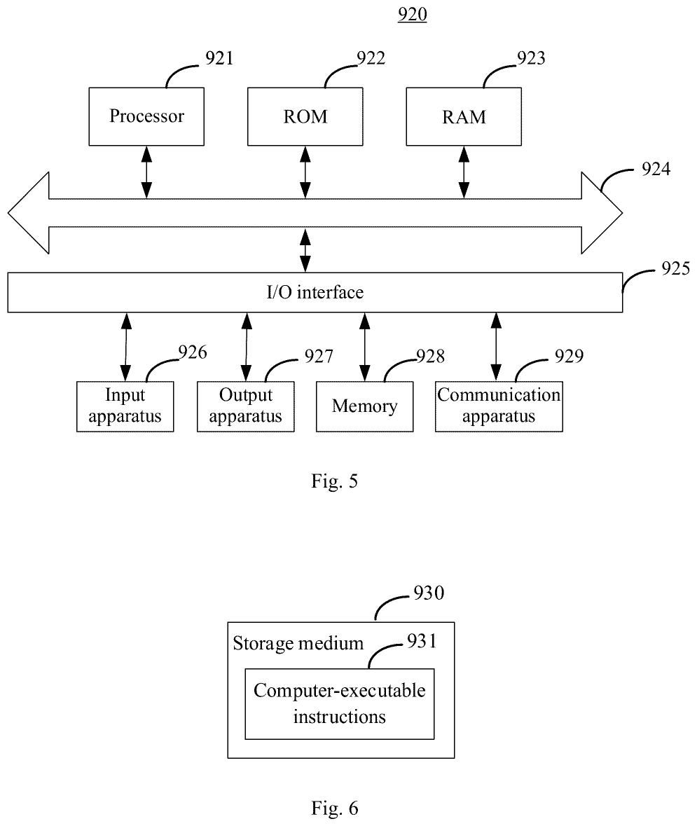

FIG. 5 is a schematic block diagram of another electronic device according to some embodiments of the present disclosure. The electronic device 920 is, for example, adapted to implement the instant messaging chat information processing method provided in the embodiments of the present disclosure. The electronic device 920 may be a terminal device or the like, and may be configured to implement a client or a server. The electronic device 920 may include, but is not limited to, a mobile terminal such as a mobile phone, a notebook computer, a digital broadcast receiver, a personal digital assistant (PDA), a tablet computer (PAD), a portable multimedia player (PMP), a vehicle-mounted terminal (such as a vehicle navigation terminal), and a wearable electronic device, and a fixed terminal such as a digital TV, a desktop computer, and a smart home device. It should be noted that, the electronic device 920 shown in FIG. 5 is merely an example, and does not impose any limitation on the function and scope of use of the embodiments of the present disclosure.

As shown in FIG. 5, the electronic device 920 may include a processor (e.g., a central processing unit or a graphics processing unit) 921 that may perform a variety of appropriate actions and processing in accordance with a program stored in a read-only memory (ROM) 922 or a program loaded from a memory 928 into a random access memory (RAM) 923. The RAM 923 further stores various programs and data required for the operation of the electronic device 920. The processor 921, the ROM 922, and the RAM 923 are connected to each other through a bus 924. An input/output (I/O) interface 925 is also connected to the bus 924.

Generally, the following apparatuses may be connected to the I/O interface 925: an input apparatus 926 including, for example, a touchscreen, a touchpad, a keyboard, a mouse, a camera, a microphone, an accelerometer, and a gyroscope; an output apparatus 927 including, for example, a liquid crystal display (LCD), a speaker, and a vibrator; the memory 928 including, for example, a tape and a hard disk; and a communication apparatus 929. The communication apparatus 929 may allow the electronic device 920 to perform wireless or wired communication with other electronic devices to exchange data. Although FIG. 5 shows the electronic device 920 having various apparatuses, it should be understood that it is not required to implement or have all of the apparatuses shown, and the electronic device 920 may alternatively implement or have more or fewer apparatuses.

For example, according to an embodiment of the present disclosure, the foregoing instant messaging chat information processing method may be implemented as a computer software program. For example, this embodiment of the present disclosure includes a computer program product, which includes a computer program carried on a non-transitory computer-readable medium, where the computer program includes program code for performing the foregoing instant messaging chat information processing method. In such an embodiment, the computer program may be downloaded and installed from a network through the communication apparatus 929, installed from the memory 928, or installed from the ROM 922. The computer program, when executed by the processor 921, may implement the functions defined in the instant messaging chat information processing method provided in the embodiments of the present disclosure.

FIG. 6 is a schematic diagram of a storage medium according to some embodiments of the present disclosure. For example, as shown in FIG. 6, the storage medium 930 may be a non-transitory computer-readable storage medium for storing non-transitory computer-executable instructions 931. The non-transitory computer-executable instructions 931, when executed by a processor, may implement the instant messaging chat information processing method described in the embodiments of the present disclosure. For example, the non-transitory computer-executable instructions 931, when executed by a processor, may perform one or more of the steps in the instant messaging chat information processing method described above.

For example, the storage medium 930 may be applied to the electronic device. For example, the storage medium 930 may include the memory in the electronic device.

For example, the storage medium may include a memory card of a smartphone, a storage component of a tablet computer, a hard disk of a personal computer, a random access memory (RAM), a read-only memory (ROM), an erasable programmable read-only memory (EPROM), a portable compact disk read-only memory (CD-ROM), a flash memory, or any combination of the above storage media, or may be other suitable storage media.

For example, for the description of the storage medium 930, reference may be made to the description of the memory in the embodiments of the electronic device, and details of the repeated parts are not described. For the specific function and technical effect of the storage medium 930, reference may be made to the above description of the instant messaging chat information processing method, and details are not described herein again.

It should be noted that in the context of the present disclosure, a computer-readable medium may be a tangible medium that may contain or store a program used by or in combination with an instruction execution system, apparatus, or device. The computer-readable medium may be a computer-readable signal medium, a computer-readable storage medium, or any combination thereof. Examples of the computer-readable storage medium may include, but are not limited to: electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

Those skilled in the art may readily figure out other implementation solutions of the present disclosure after considering the present disclosure. The present disclosure is intended to cover any variations, purposes, or adaptive changes of the present disclosure. Such variations, purposes, or adaptive changes follow the general principle of the present disclosure and include common knowledge or conventional technical means in the art which is not disclosed in the present disclosure. The present disclosure and embodiments are merely considered as examples, and the true scope and spirit of the present disclosure are defined by the claims.

It should be understood that the present disclosure is not limited to the exact structure that has been described above and shown in the accompanying drawings, and various modifications and changes may be made without departing from the scope of the present disclosure. The scope of the present disclosure is defined by the appended claims.

1. An instant messaging chat information processing method, comprising:
receiving a chat mode switching operation for a target chat; and
switching the target chat from a first chat mode to a second chat mode in response to the chat mode switching operation,
wherein chat message management manners in different chat modes are different, and the first chat mode and the second chat mode are different chat modes.

2. The instant messaging chat information processing method according to claim 1, wherein the chat message management manners in the different chat modes being different, comprises: at least one of a chat message display manner, a chat message sending manner, and a chat message notification manner in the different chat modes being different.

3. The instant messaging chat information processing method according to claim 1, wherein after the switching the target chat from the first chat mode to the second chat mode,
a display manner of a chat message that has been generated in the target chat before the switching remains unchanged; and
a new chat message that is generated in the target chat after the switching is displayed in a chat message display manner corresponding to the second chat mode.

4. The instant messaging chat information processing method according to claim 1, wherein the switching the target chat from the first chat mode to the second chat mode in response to the chat mode switching operation, comprises:
sending a chat mode switching request to a server in response to the chat mode switching operation;
receiving a chat attribute set sent by the server, wherein the chat attribute set comprises a chat mode attribute; and
switching the target chat from the first chat mode to the second chat mode when an attribute value of the chat mode attribute comprised in the chat attribute set is determined to correspond to the second chat mode.

5. The instant messaging chat information processing method according to claim 4, wherein after the sending the chat mode switching request to the server, the instant messaging chat information processing method further comprises:
receiving a notification message sent by the server, wherein the notification message indicates a change in a chat mode of the target chat; and
displaying the notification message in a target chat interface.

6. The instant messaging chat information processing method according to claim 1, wherein before receiving the chat mode switching operation, the instant messaging chat information processing method further comprises: displaying a chat mode switching interface corresponding to the target chat for a user that has a preset permission,
wherein the receiving the chat mode switching operation for the target chat, comprises: receiving the chat mode switching operation performed by the user that has the preset permission for the target chat on the chat mode switching interface.

7. The instant messaging chat information processing method according to claim 1, wherein the first chat mode is a normal mode, and the second chat mode is a topic mode.

8. The instant messaging chat information processing method according to claim 7, wherein after switching the target chat from the normal mode to the topic mode, the instant messaging chat information processing method further comprises:
hiding a message input box displayed for the target chat in the normal mode, and displaying a topic creation button; and
displaying a topic input box in response to an operation of triggering the topic creation button by a user.

9. The instant messaging chat information processing method according to claim 7, wherein a chat message corresponding to the topic mode is displayed in a following manner:
displaying a topic card corresponding to each topic in the target chat, wherein a respective topic card corresponding to any topic displays topic content corresponding to the any topic.

10. The instant messaging chat information processing method according to claim 9, further comprising:
in response to an operation of viewing a topic by a user, expanding a topic detail interface corresponding to the topic in a sidebar, and displaying detailed content corresponding to the topic in the topic detail interface.

11. The instant messaging chat information processing method according to claim 10, wherein the operation of viewing the topic comprises: an operation of triggering an avatar of a creator of the topic, or an operation of triggering the topic card corresponding to the topic.

12. (canceled)

13. A non-transitory computer-readable storage medium, storing a computer program, wherein when the computer program is executed in a computer, the computer is caused to execute an instant messaging chat information processing method, and the instant messaging chat information processing method comprises:
receiving a chat mode switching operation for a target chat; and
switching the target chat from a first chat mode to a second chat mode in response to the chat mode switching operation,
wherein chat message management manners in different chat modes are different, and the first chat mode and the second chat mode are different chat modes.

14. An electronic device, comprising a memory and a processor, wherein the memory stores executable code, when the processor executes the executable code, the processor implements an instant messaging chat information processing method, and the instant messaging chat information processing method comprises:
receiving a chat mode switching operation for a target chat; and
switching the target chat from a first chat mode to a second chat mode in response to the chat mode switching operation,
wherein chat message management manners in different chat modes are different, and the first chat mode and the second chat mode are different chat modes.

15. The instant messaging chat information processing method according to claim 2, wherein after the switching the target chat from the first chat mode to the second chat mode,
a display manner of a chat message that has been generated in the target chat before the switching remains unchanged; and
a new chat message that is generated in the target chat after the switching is displayed in a chat message display manner corresponding to the second chat mode.

16. The electronic device according to claim 14, wherein the chat message management manners in different chat modes being different, comprises: at least one of a chat message display manner, a chat message sending manner, and a chat message notification manner in different chat modes being different.

17. The electronic device according to claim 14, wherein after the switching the target chat from the first chat mode to the second chat mode,
a display manner of a chat message that has been generated in the target chat before the switching remains unchanged; and
a new chat message that is generated in the target chat after the switching is displayed in a chat message display manner corresponding to the second chat mode.

18. The electronic device according to claim 14, wherein the switching the target chat from the first chat mode to the second chat mode in response to the chat mode switching operation, comprises:
sending a chat mode switching request to a server in response to the chat mode switching operation;
receiving a chat attribute set sent by the server, wherein the chat attribute set comprises a chat mode attribute; and
switching the target chat from the first chat mode to the second chat mode when an attribute value of the chat mode attribute comprised in the chat attribute set is determined to correspond to the second chat mode.

19. The electronic device according to claim 18, wherein after the sending the chat mode switching request to the server, the instant messaging chat information processing method further comprises:
receiving a notification message sent by the server, wherein the notification message indicates a change in a chat mode of the target chat; and
displaying the notification message in a target chat interface.

20. The electronic device according to claim 14, wherein before receiving the chat mode switching operation, the instant messaging chat information processing method further comprises: displaying a chat mode switching interface corresponding to the target chat for a user that has a preset permission,
wherein the receiving the chat mode switching operation for the target chat, comprises: receiving the chat mode switching operation performed by the user that has the preset permission for the target chat on the chat mode switching interface.

21. The electronic device according to claim 14, wherein the first chat mode is a normal mode, and the second chat mode is a topic mode.
